(19) United States
(12) Patent Application Publication
(10) Pub. No.: US 2022/0294378 A1
(43) Pub. Date: Sep. 15, 2022

(54) MOTOR CONTROL DEVICE AND MOTOR CONTROL METHOD

(71) Applicant: Nidec Corporation, Kyoto (JP)

(72) Inventors: Tomohiro FUKUMURA, Kyoto (JP); Linfeng LAN, Kawasaki-shi (JP)

(21) Appl. No.: 17/633,969

(22) PCT Filed: Jul. 22, 2020
(86) PCT No.: PCT/JP2020/028537

§ 371 Date: Feb. 9, 2022

(30) Foreign Application Priority Data
Aug. 21, 2019 (JP) 2019-151274

(51) Int. Cl. H02P 23/04; H02P 27/08

(52) U.S. Cl. CPC H02P 23/04; H02P 27/08

(57) ABSTRACT

In a DC/DC converter, a voltage input from a power source is converted into a predetermined voltage, a harmonic component generated by a harmonic signal generator is superimposed on the converted voltage, and a result is output to the inverter as power to drive an electric motor. As a result, the electric motor can be driven by the signal on which the harmonic components are superimposed without being limited to the upper limit of the switching frequency of the inverter.

### CROSS-REFERENCE TO RELATED APPLICATIONS

This is a U.S. national stage of application No. PCT/JP2020/028537, filed on Jul. 22, 2020, and with priority under 35 U.S.C. § 119(a) and 35 U.S.C. § 365(b) being claimed from Japanese Patent Application No. 2019-151274, filed on Aug. 21, 2019, the entire disclosures of which are hereby incorporated herein by reference.

### 1. FIELD OF THE INVENTION

The present disclosure relates to a motor control device and a motor control method for an electric motor used in, for example, an electric vehicle, a hybrid vehicle, and the like.

### 2. BACKGROUND

The current flowing through the electric motor includes a harmonic component in addition to a fundamental wave component. A torque ripple is generated due to the harmonic component, which causes vibration and noise. Therefore, in the control of the electric motor, it is important to suppress the generation of the ripple appearing in the output torque.

When an electric motor is driven by an inverter, a technique of suppressing a torque ripple of the electric motor by superimposing, on an AC signal from the inverter, a harmonic component of an integral multiple of an AC current in addition to a fundamental wave is conventionally known.

For example, there is known a motor control device that prepares an induced voltage ripple table in which a voltage on a dq-axis that offsets a torque ripple component other than a basic sine wave from an induced voltage waveform obtained by magnetic field analysis of a motor is used as a table, and adds a voltage on the dq-axis read from the table to a dq-axis voltage command according to a rotation angle of the motor to reduce the torque ripple of the motor.

There is known a torque ripple suppression system that extracts a torque ripple component of a motor, learns a compensation current for suppressing the torque ripple on the basis of the torque ripple component to generate a table, and applies the compensation current to an inverter of the motor to suppress the torque ripple for each frequency component.

With an increase in speed of a motor in recent years, a frequency band of harmonic components to be superimposed in addition to a fundamental wave is extremely high. Therefore, as described above, there is a problem that even if it is attempted to suppress the torque ripple of the electric motor by superimposing a harmonic component on the current or voltage command to the inverter, the harmonic cannot be generated at the switching frequency of the inverter, and the torque ripple suppression cannot be coped with.

For example, when a motor of four pole pairs rotates at 12000 rpm, the fundamental wave becomes 800 Hz, and its 6th harmonic reaches 4.8 kHz. On the other hand, the upper limit of the switching frequency of the inverter is about 20 kHz due to a switching loss, an increase in iron loss of the motor, and the like. Since the switching frequency is limited by the frequency of the switching element to be used, the switching frequency is about 10 kHz when an insulated gate bipolar transistor (IGBT) is used.

When the switching frequency of the inverter is 10 to 20 kHz, it can be seen from the sampling theorem that a harmonic of 4.8 kHz as described above cannot be generated as a harmonic component to be superimposed. For example, in a case where the switching frequency is 10 kHz, the frequency determined based on the Nyquist frequency according to the sampling theorem is 1 kHz, the inverter cannot cope with harmonics of 1 kHz or more (the above-described 6th harmonic of 4.8 kHz), and it is difficult to reproduce an ideal sine wave signal waveform to be applied, so that there is a problem that the torque ripple cannot be reduced.

### SUMMARY

Example embodiments of the present disclosure are able to solve the abovementioned problem. An example embodiment of the present disclosure is a motor control device that drives an electric motor, the motor control device including a power source, a first power converter to convert a voltage input from the power source into a predetermined voltage, superimpose a predetermined frequency component on the converted voltage, and output the voltage, and a second power converter to convert an output from the first power converter into power to drive the electric motor.

Another example embodiment of the present disclosure is a vehicle including an electric motor to drive the vehicle and a controller to drive and control the electric motor by the motor control device according to the first example embodiment of the present disclosure.

Still another example embodiment of the present disclosure is a motor control method of an electric motor driven by receiving a power supply from a power source, the method including generating a signal of a predetermined frequency component, converting a voltage input from the power source into a predetermined voltage, superimposing the predetermined frequency component on the converted voltage, and outputting the voltage, converting the output obtained in the first voltage conversion step into power to drive the electric motor.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a block diagram illustrating an overall configuration of a motor control device according to an example embodiment of the present disclosure.

FIG. 2 is a flowchart illustrating an operation example of an electric motor in a motor control device according to an example embodiment of the present disclosure.

FIG. 3A is an output voltage waveform of a conventional DC/DC converter on which no harmonic component is superimposed.

FIG. 3B is an output voltage waveform of the DC/DC converter on which harmonic components are superimposed.

FIG. 4A is a conventional inverter output voltage waveform in which harmonic components are not superimposed in the DC/DC converter.

FIG. 4B is an inverter output voltage waveform when harmonic components are superimposed in the DC/DC converter.

FIG. 5A illustrates a torque ripple in a conventional example in which harmonic components are not superimposed in the DC/DC converter.

FIG. 5B illustrates a torque ripple when harmonic components are superimposed in the DC/DC converter.

### DETAILED DESCRIPTION

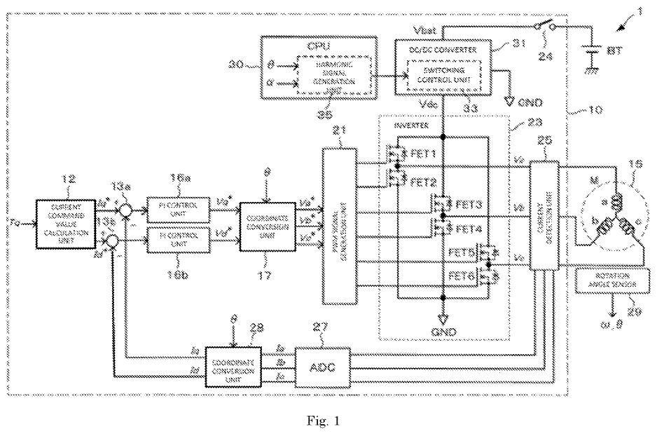

Example embodiments according to the present disclosure will be described in detail below with reference to the accompanying drawings. FIG. 1 is a block diagram illustrating an overall configuration of a motor control device according to an example embodiment of the present disclosure. The motor control device is mounted on a vehicle using an electric motor as a drive source, for example.

A motor control device 1 illustrated in FIG. 1 includes a motor control unit 10 that functions as a drive control unit of an electric motor 15 that is, for example, a three-phase brushless DC motor. The motor control unit 10 includes an external battery BT, a DC/DC converter 31, an inverter 23, and the like.

The DC/DC converter 31 is a converter that is disposed between the external battery BT and the inverter 23 and can step up and down an input voltage. That is, the DC/DC converter 31 steps up or down a voltage V_{bat} supplied from the external battery BT via a power source relay 24 by switching control of the built-in semiconductor element, and supplies the stepped up-or-down voltage V_{dc} to the inverter 23.

As a semiconductor switching element used in the DC/DC converter 31, for example, a switching element made of a wide bandgap semiconductor such as silicon carbide (SiC) or gallium nitride (GaN) can be adopted. This enables downsizing of the DC/DC converter 31.

A motor control device 10 removes a torque ripple caused by a 6th harmonic component of the fundamental frequency of the PWM control or a high frequency component that is an integral multiple thereof, which appears in the output shaft torque of the electric motor 15. Therefore, a high-frequency harmonic signal (for example, the component is a 6n-th harmonic component, and n is an integer of 1 or more) generated by a harmonic signal generator 35 in a control unit (CPU) 30 is input to the DC/DC converter 31.

A switching control unit 33 of the DC/DC converter 31 performs DC/DC power conversion according to a predetermined voltage command value, and performs control to superimpose the 6n-th harmonic component input from the harmonic signal generator 35 on the output V_{dc} from the DC/DC converter 31.

The switching frequency of the switching control unit 33 is, for example, 150 to 300 kHz. By using the DC/DC converter having a high switching frequency in this manner, a harmonic component having a high frequency can be superimposed on the voltage supplied for driving the electric motor 15.

The control unit (CPU) 30 includes, for example, a microprocessor operated by a control program (software) stored in a memory (not illustrated). The CPU 30 functions as an adjuster that causes the harmonic signal generator 35 to adjust the amplitude and phase of the 6n-th frequency component superimposed on the output of the DC/DC converter 31 to the amplitude and phase of the 6n-th harmonic component of the driving frequency of the electric motor 15.

By providing such an adjuster, a signal of a frequency component generated in accordance with a harmonic component (6n-th harmonic component) to be subjected to torque ripple reduction can be superimposed on the output of the DC/DC converter, whereby a remarkable reduction effect of torque ripple can be obtained in the motor control device.

The inverter 23 functions as a motor drive circuit that generates an alternating current for driving the electric motor 15 from the voltage supplied from the DC/DC converter 31 and on which the 6n-th harmonic component is superimposed. Note that the power source relay 24 is configured to be able to cut off power from the battery BT, and can be configured as a semiconductor relay.

A PWM signal generator 21 generates ON/OFF control signals (PWM signals) of a plurality of semiconductor switching elements (FETs 1 to 6) constituting the inverter 23 according to a voltage command value to be described later. These semiconductor switching elements correspond to the respective phases (Phase a, Phase b, Phase c) of the electric motor 15.

The switching element (FET) is also called a power element, and for example, a switching element such as a MOSFET (Metal-Oxide Semiconductor Field-Effect Transistor) or an IGBT (Insulated Gate Bipolar Transistor) is used.

A motor drive current supplied from the inverter 23 as a motor drive circuit to the electric motor 15 is detected by a current detection unit 25 including current sensors (not illustrated) arranged corresponding to the respective phases. The current detection unit 25 detects, for example, a direct current flowing through a shunt resistor for detecting a motor drive current using an amplifier circuit including an operational amplifier or the like.

An output signal (current detection signal) from the current detection unit 25 is input to an A/D converter (ADC) 27. The ADC 27 converts an analog current value into a digital value by the A/D conversion function, and the three-phase currents Ia, Ib, and Ic obtained by the conversion are input to a coordinate conversion unit 28.

The coordinate conversion unit 28 has a three-phase/two-phase transformation function, and calculates the current Id on the d-axis and the current Iq on the q-axis from the rotation angle θ detected by a rotation angle sensor 29 and the three-phase currents Ia, Ib, and Ic. That is, the coordinate conversion unit 28 calculates the d-axis current and the q-axis current based on the actual currents.

A current command value calculation unit 12 obtains a current command value (target current value) from the external instruction torque Tq. Specifically, the current command value calculation unit 12 calculates a d-axis command current Id* as a magnetic field component and a q-axis command current Iq* as a torque component based on the instruction torque Tq. Then, a subtractor 13a calculates a difference (denoted as Dq) between the q-axis command current Iq* and the q-axis current Iq, and a subtractor 13b calculates a difference (denoted as Dd) between the d-axis command current Id* and the d-axis current Id.

As a current control unit, PI control units 16a and 16b obtain voltage command values for the d axis and the q axis so as to make a difference between the current command values for the d axis and the q axis and the detected current values 0. Then, a coordinate conversion unit 17 calculates a voltage V* to be applied to the motor from the voltage command value and the rotation angle of the electric motor 15.

That is, Dq is input to the PI control unit 16a, and Dd is input to the PI control unit 16b. The PI control unit 16a performs proportional integral (PI) control so as to converge Dq to 0, and calculates a q-axis voltage command value Vq* that is a command value of the q-axis voltage. Similarly, the PI control unit 16b performs proportional integral (PI) control so as to converge Dd to 0, thereby calculating a d-axis voltage command value Vd* that is a command value of the d-axis voltage.

The q-axis voltage command value Vq* and the d-axis voltage command value Vd* are input to the coordinate conversion unit 17 having a two-phase/three-phase conversion function. The coordinate conversion unit 17 converts Vq* and Vd* into voltage command values Va*, Vb*, and Vc*, which are voltage command values for each of the three phases, based on the rotation angle θ. The converted voltage command values Va*, Vb*, and Vc* are input to the PWM signal generator 21. The PWM signal generator 21 generates a drive signal (PWM signal) for the electric motor 15 based on these current command values.

Note that the DC/DC converter 31 may be configured to incorporate the harmonic signal generator 35. In addition, a filter for noise removal may be disposed between the DC/DC converter 31 and the inverter 23. In this case, the output voltage on which the harmonic components from the DC/DC converter 31 are superimposed is indirectly input to the inverter 23 via the filter.

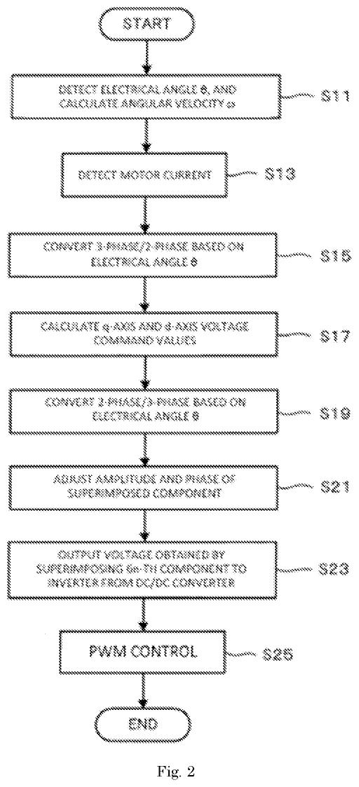

Next, a method of driving and controlling the electric motor in the motor control device according to the present example embodiment will be described. FIG. 2 is a flowchart illustrating drive and control (operation example) of the electric motor in the motor control device according to the present example embodiment.

In Step S11 of FIG. 2, the motor control device 10 calculates an angular velocity ω of the electric motor 15 based on the electrical angle (rotation angle) θ detected by a rotation angle sensor 51. In subsequent Step S13, the motor current is detected. Here, as described above, the current detection signal from the current detection unit 25 is A/D-converted by the ADC 27 to obtain the three-phase currents Ia, Ib, and Ic as digital values.

In Step S15, the current Id on the d axis and the current Iq on the q axis are calculated from the rotation angle θ detected in Step S11 and the three-phase currents Ia, Ib, and Ic obtained in Step S13 by the three-phase/two-phase conversion by the coordinate conversion unit 28.

In Step S17, the current command value calculation unit 12 calculates the d-axis command current Id* and the q-axis command current Iq* based on the instruction torque Tq, and then performs PI control on a difference between the q-axis command current Iq* and the q-axis current Iq to calculate the q-axis voltage command value Vq* that is a command value of the q-axis voltage. Further, PI control is performed on a difference between the d-axis command current Id* and the d-axis current Id to calculate the d-axis voltage command value Vd* which is a command value of the d-axis voltage.

In Step S19, the voltage command values Va*, Vb*, and Vc*, which are voltage command values for each of the three phases, are obtained based on the q-axis voltage command value Vq* and the d-axis voltage command value Vd* calculated in Step S17 and the rotation angle θ by two-phase/three-phase conversion in the coordinate conversion unit 17.

Next, processing for removing torque ripple (high-order vibration component) appearing in the output shaft torque of the electric motor is performed. Here, the 6th harmonic component of the fundamental frequency or the high-frequency component of an integral multiple thereof, which is the main component of the high-order torque ripple component, is removed.

Therefore, in Step S21, the CPU 30 of the motor control device 10 adjusts the amplitude and phase of the 6n-th harmonic (n is an integer of 1 or more) in the output voltage V_{dc} of the DC/DC converter as shown by the following Expression (1) in accordance with the amplitude and phase of the 6n-th harmonic component of the driving frequency of the electric motor 15.

V_{dc}=V_{dc0}+V_{dc6n} sin(6nθ+α) (1)

Here, V_{dc0} is the voltage of the fundamental wave, V_{dc6n} is the voltage (amplitude) of the 6n-th harmonic wave, θ is the electrical angle of the rotor of the electric motor 15, and α is the phase.

The amplitude V_{dc6n} and the phase α of Expression (1) are calculated using a method known in the related art as a method of suppressing the torque ripple. For example, the calculation is performed based on the voltage and the phase of the 6th harmonic component on the dq-axis to be added to the dq-axis voltage command based on the instruction torque Tq from the outside. Alternatively, the voltage and the phase of the 6th harmonic component may be tuned (adjusted) according to the magnitude of the torque ripple occurred in the electric motor.

In Step S23, a voltage obtained by superimposing the 6n-th harmonic component shown in the above Expression (1) in the DC/DC converter 31 is applied to the inverter 23 as the output voltage V_{dc} from the DC/DC converter 31. The CPU 30 performs control such that the order n of the 6n-th frequency component increases as the rotational speed (angular velocity ω) of the electric motor 15 increases.

In Step S25, the voltage command values Va*, Vb*, and Vc* for each of the three phases obtained in Step S19 are input to the PWM signal generator 21. The PWM signal generator 21 generates a drive signal (PWM signal) for the electric motor 15 based on these current command values.

As a result, harmonic components difficult to be superimposed in the inverter 23 can be superimposed in the DC/DC converter 31, and the output voltage of the DC/DC converter 31 in which the 6n-th harmonic component, which is a harmonic component to be subjected to torque ripple reduction, is superimposed on the fundamental wave component is supplied to the inverter 23. Therefore, since the output power of the DC/DC converter 31 on which the 6n-th harmonic component is superimposed serves as a power source for driving the electric motor 15, it is possible to obtain an effect of reducing the torque ripple caused by the 6n-th harmonic component in the electric motor 15.

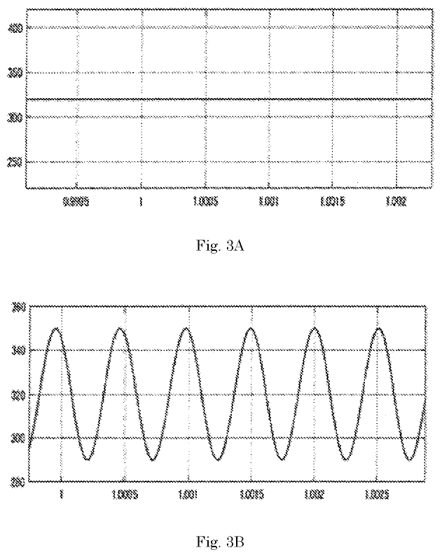

Next, a torque ripple reduction effect in the motor control device according to the present example embodiment will be described. FIGS. 3 to 5 simulate effects in a case where no harmonic component is superimposed on the output voltage and in a case where a 6th harmonic component is superimposed on the output voltage in the DC/DC converter, and illustrate comparison therebetween.

FIG. 3A is an output voltage waveform of the conventional DC/DC converter on which no harmonic component is superimposed, and FIG. 3B is an output voltage waveform of the DC/DC converter 31 on which a harmonic component is superimposed. In FIGS. 3A and 3B, the horizontal axis represents time.

As can be seen from FIG. 3B, by superimposing the harmonic component (here, the 6th harmonic component) in the DC/DC converter 31, a voltage (V_{dc} described above) in which the 6th harmonic component is superimposed on the fundamental wave component is output.

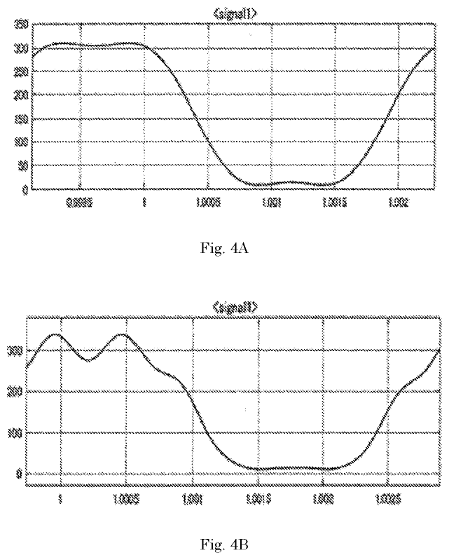

FIG. 4A is a conventional inverter output voltage waveform in which harmonic components are not superimposed in the DC/DC converter, and FIG. 4B is a simulation result of the inverter output voltage waveform when the harmonic components are superimposed in the DC/DC converter 31. In FIGS. 4A and 4B, the horizontal axis represents time.

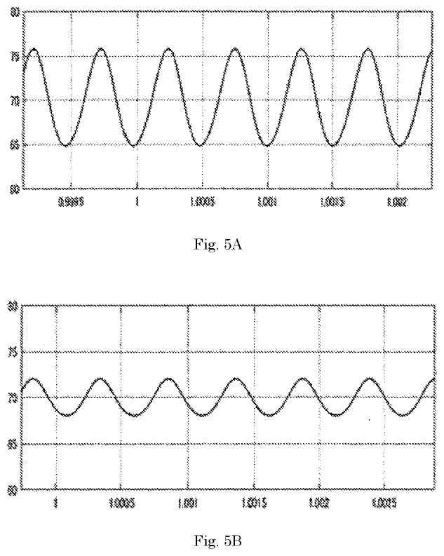

FIG. 5A is a simulation result of the torque ripple in the conventional example in which harmonic components are not superimposed in the DC/DC converter, and FIG. 5B is a simulation result of the torque ripple when harmonic components are superimposed in the DC/DC converter 31. In FIGS. 5A and 5B, the horizontal axis represents time.

As can be seen from FIG. 5B, by superimposing harmonic components in the DC/DC converter 31, the effect of reducing the torque ripple remarkably appears as compared with the conventional example in FIG. 5A.

In a case where the motor control device according to the present example embodiment is mounted on a vehicle such as an electric vehicle or a hybrid vehicle, for example, it is possible to reduce a torque ripple in an electric motor serving as a power source of these vehicles.

As described above, the motor control device according to the present example embodiment includes the DC/DC converter that converts the voltage input from the power source into a predetermined voltage and superimposes the harmonic component in the high frequency region on the converted voltage to output, and the inverter that converts the output power from the DC/DC converter into the driving power of the electric motor, so that the electric motor can be driven by the power on which the harmonic component is superimposed in the DC/DC converter without being limited to the upper limit of the switching frequency of the inverter.

That is, the frequency of the harmonic component to be superimposed can be matched not with the upper limit of the switching frequency of the inverter but with the upper limit of the switching frequency of the DC/DC converter, whereby the torque ripple caused by the harmonic component of the electric motor can be reduced.

As a result, vibration and noise of the motor control device caused by the torque ripple of the motor can be reduced. In particular, by adopting a configuration in which harmonic components are superimposed in an in-vehicle DC/DC converter having a high switching frequency, it is possible to obtain a remarkable effect in reduction of motor drive noise associated with a torque ripple of a high frequency.

In addition, the 6n-th torque ripple, which is a factor of the torque ripple, can be effectively reduced by using the 6n-th harmonic component as the harmonic component to be superimposed. That is, since the signal of the frequency component matched with the harmonic component (6n-th harmonic component) to be subjected to the torque ripple reduction can be superimposed on the output of the DC/DC converter, a remarkable reduction effect of the torque ripple can be obtained at the time of high rotation of the electric motor.

Furthermore, in both the step-up type and step-down type DC/DC converters, only by adding the configuration for superimposing the harmonic component to the existing power conversion configuration, it is not necessary to change the inverter control method and the carrier frequency (switching frequency). Therefore, it is possible to reduce the cost and size of the motor control device for reducing the torque ripple.

The present disclosure is not limited to the above-described example embodiments, and can be appropriately changed. For example, when the 6n-th harmonic component to be superimposed is equal to or higher than the frequency (for example, 1 kHz) determined based on the Nyquist frequency according to the sampling theorem with respect to the carrier frequency (switching frequency) of the PWM drive signal in the inverter control in the inverter 23, the output obtained by superimposing the 6n-th harmonic component in the DC/DC converter 31 may be supplied to the inverter 23 to suppress the torque ripple of the electric motor, and when the 6n-th harmonic component is 1 kHz or less, the harmonic component may be superimposed on the current or voltage command to the inverter to suppress the torque ripple of the electric motor as in the related art.

Features of the above-described preferred example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-16. (canceled)

17. A motor control device that drives an electric motor, the motor control device comprising:
a power source;
a first power converter to convert a voltage input from the power source into a predetermined voltage, superimpose a predetermined frequency component on the converted voltage, and output the voltage; and
a second power converter to convert an output from the first power converter into power to drive the electric motor.

18. The motor control device according to claim 17, wherein the predetermined frequency component is generated based on a harmonic component of a driving frequency of the electric motor.

19. The motor control device according to claim 18, wherein the harmonic component is a 6n-th harmonic component, with n being an integer of 1 or more.

20. The motor control device according to claim 17, further comprising an adjuster to adjust an amplitude and a phase of the frequency component to be superimposed to an amplitude and a phase of a harmonic component of a driving frequency of the electric motor.

21. The motor control device according to claim 17, wherein the first power converter steps up or down a voltage input from the power source to a predetermined voltage.

22. The motor control device according to claim 17, wherein the first power converter is a DC/DC converter, and the second power converter is an inverter.

23. The motor control device according to claim 22, wherein the DC/DC converter includes a semiconductor switch including a wide bandgap semiconductor including a silicon carbide-based material and a gallium nitride-based material.

24. The motor control device according to claim 23, wherein a switching frequency of the DC/DC converter is about 150 kHz to about 300 kHz.

25. The motor control device according to claim 22, wherein the first power converter superimposes a 6n-th harmonic component when the 6n-th harmonic component is equal to or higher than a frequency determined based on a Nyquist frequency according to a sampling theorem for a switching frequency of the inverter.

26. The motor control device according to claim 25, wherein the determined frequency is about 1 kHz.

27. The motor control device according to claim 17, wherein the motor control device is mounted on a vehicle for in-vehicle use.

28. A vehicle equipped with the motor control device according to claim 17.

29. A motor control method of an electric motor driven by receiving power supply from a power source, the method comprising:
generating a signal of a predetermined frequency component;
converting a voltage input from the power source into a predetermined voltage, superimposing the predetermined frequency component on the converted voltage, and outputting the voltage; and
converting the output obtained in the first voltage conversion step into power to drive the electric motor.

30. The motor control method according to claim 29, wherein the predetermined frequency component is generated based on a harmonic component of a driving frequency of the electric motor.

31. The motor control method according to claim 30, wherein the harmonic component is a 6n-th harmonic component, with n being an integer of 1 or more.

32. The motor control method according to claim 29, wherein, in generating the signal of the predetermined frequency component, the method further includes performing adjustment processing of adjusting an amplitude and a phase of the frequency component to be superimposed with an amplitude and a phase of a harmonic component of a driving frequency of the electric motor.
